(19) United States
(12) Patent Application Publication
(10) Pub. No.: US 2025/0150812 A1
(43) Pub. Date: May 8, 2025

(54) SECURE WIRELESS TRANSMISSION MECHANISMS

(71) Applicant: QUALCOMM Incorporated, San Diego, CA (US)

(72) Inventors: Ahmed ELSHAFIE, San Diego, CA (US); Hung Dinh LY, San Diego, CA (US); Ahmed Attia ABOTABL, San Diego, CA (US); Muhammad Sayed Khairy ABDELGHAFFAR, San Jose, CA (US); Alexandros MANOLAKOS, Athens (GR); Yuchul KIM, San Diego, CA (US)

(21) Appl. No.: 18/867,777

(22) PCT Filed: Jul. 10, 2023
(86) PCT No.: PCT/US2023/069900

§ 371 Date: Nov. 20, 2024

(30) Foreign Application Priority Data
Jul. 18, 2022 (GR) 20220100566

(51) Int. Cl. H04W 12/033; H04W 12/041

(52) U.S. Cl. CPC H04W 12/033; H04W 12/041

(57) ABSTRACT

Certain aspects of the present disclosure provide a method for wireless communication, by a transmitter, generally including selecting one or more transmission parameter configurations, from a set of transmission parameter configurations associated with one or more transmission events and transmitting a signal, according to the selected one or more transmission parameter configurations, in order to protect data transmitted to a receiver.

### CROSS-REFERENCE TO RELATED APPLICATION(S)

This application claims priority to Greece Patent Application Serial No. 20220100566, filed Jul. 18, 2022, which is hereby incorporated by reference herein.

### BACKGROUND

### Field of the Disclosure

Aspects of the present disclosure relate to wireless communications, and more particularly, to techniques for enhancing security of wireless transmissions.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communications by a transmitter. The method includes selecting one or more transmission parameter configurations, from a set of transmission parameter configurations associated with one or more transmission events; and transmitting a signal, according to the selected one or more transmission parameter configurations, in order to protect data transmitted to a receiver.

Another aspect provides a method of wireless communications by a receiver. The method includes receiving a key from a transmitter; receiving a signal from the transmitter, wherein the signal comprises artificial noise (AN); and processing the signal by canceling the AN from the signal using the key.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 is a table illustrating how unprotected communications could impact performance.

FIG. 6 depicts an example scenario in which aspects of the present disclosure may enhance security.

FIG. 7 depicts an example graph illustrating the potential impact of artificial noise on security.

FIG. 8 depicts an example scenario in which the present disclosure may enhance security.

FIG. 9 is a call flow diagram illustrating example communications between a transmitter and a receiver, according to aspects of the present disclosure.

FIG. 10 depicts a table illustrating various power configurations based on transmission events, according to aspects of the present disclosure.

FIG. 11 depicts a table illustrating various TPMI configurations based on transmission events, according to aspects of the present disclosure.

FIG. 12 depicts a method for wireless communications.

FIG. 13 depicts a method for wireless communications.

FIG. 14 depicts aspects of an example communications device.

FIG. 15 depicts aspects of an example communications device.

### DETAILED DESCRIPTION

Aspects of the present disclosure provide apparatuses, methods, processing systems, and computer-readable mediums for enhancing security of wireless transmissions.

Secure communications are very important in many wireless communications systems. For example, in wireless communications systems involving Internet of Things (IoT) devices (e.g., in a factory automation scenario), security may be crucial since many devices will be connected to each other. Given the level of importance of data obtained from IoT devices, adding more security to wireless transmissions may be beneficial.

Various techniques for securing wireless communications have been developed to help increase security and privacy. These techniques include QAM rotation and artificial noise (AN) injection, which may be used to improve physical layer security. The general idea is to inject AN in a way that it could be canceled or removed at a legitimate (intended) receiver, but not at an unintended receiver (e.g., an eavesdropper).

Another technique for securing wireless communications involves using secret keys, for example, to obtain secure bits from channels and sounding signals between legitimate nodes. Unfortunately, such keys could be manipulated using several various mechanisms, including block cipher techniques, hashing and counter usage (e.g., based on symbol, subslot, slot information). Attacks based on such mechanisms may have severe impact on system performance, for example, leading to throughput degradation or even out-of-service (OOS) events.

Aspects of the present disclosure provide mechanisms that may help enhance security relative to previous mechanisms. For example, for half duplex (HD) and full duplex (FD), transmitter devices may transmit AN (with data or separately) according to one or more selected transmission parameter configurations in order to protect transmitted data. The configurations may be based on jamming and power tasks a UE is performing. Each task may be associated with a slot type and a power configuration.

By utilizing techniques presented herein, security can be added to certain channels that currently lack physical layer (PHY, also referred to as Layer 1 or L1) and Layer 3 (L3 radio resource control (RRC)) security. The techniques proposed herein may improve security and decrease potential vulnerabilities of different types of wireless transmissions whether sent on the uplink (UL) or downlink (DL), using full duplex (FD) or half-duplex (HD) schemes.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

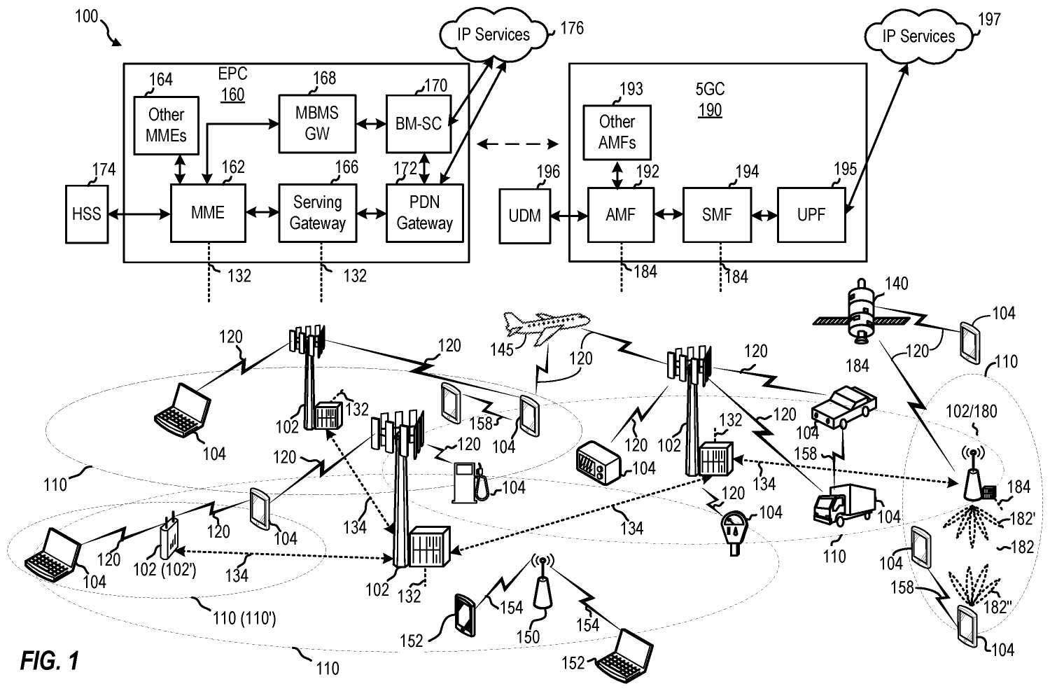

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

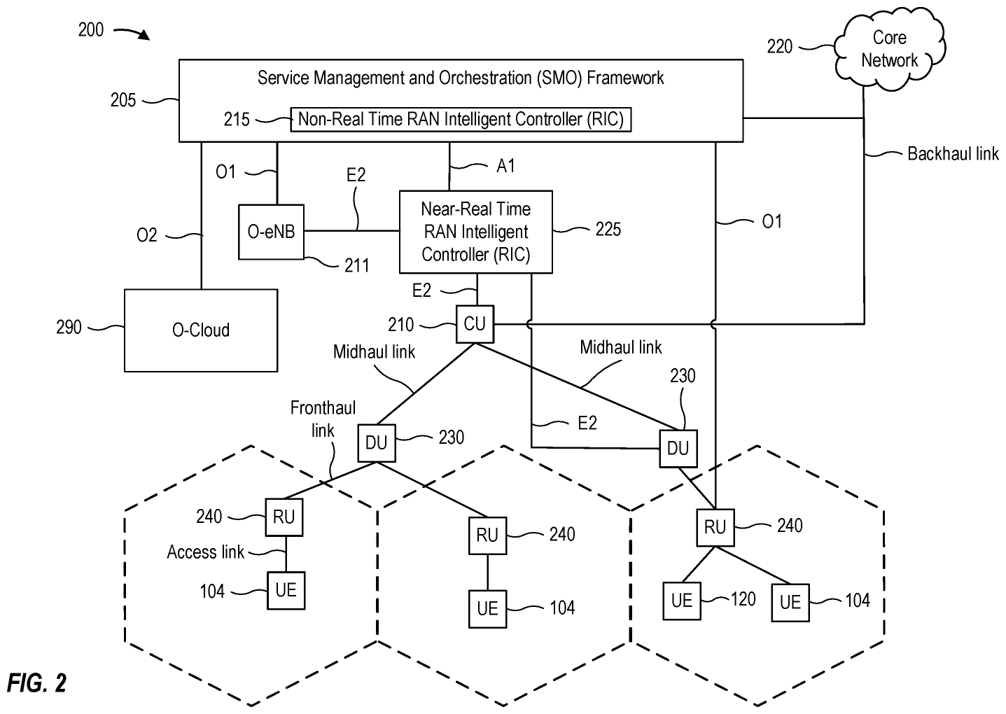

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUS), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHZ, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O₂ interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

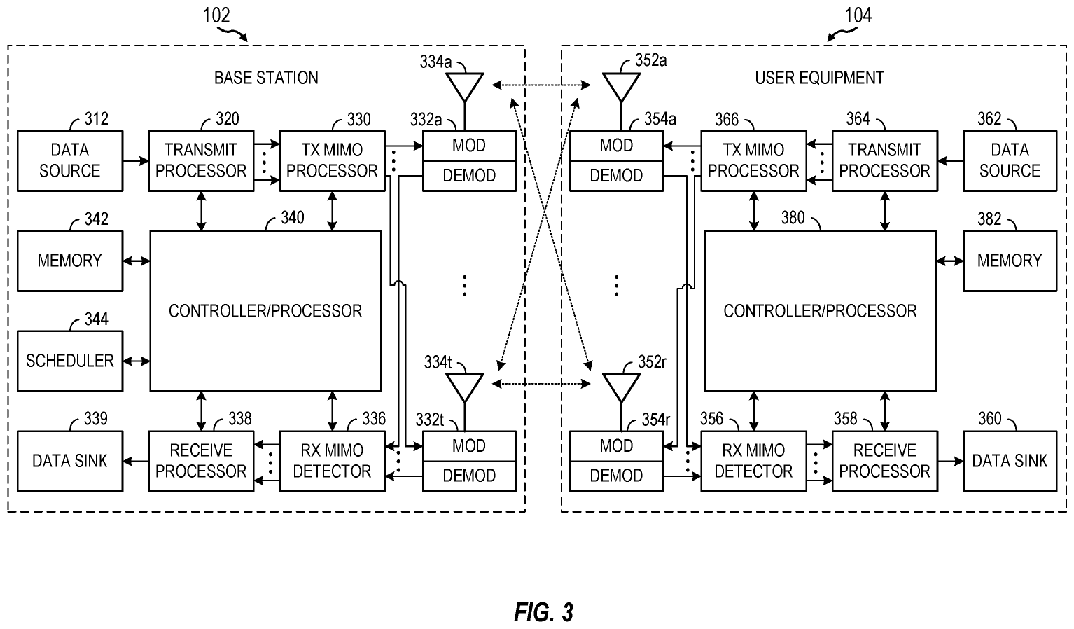

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

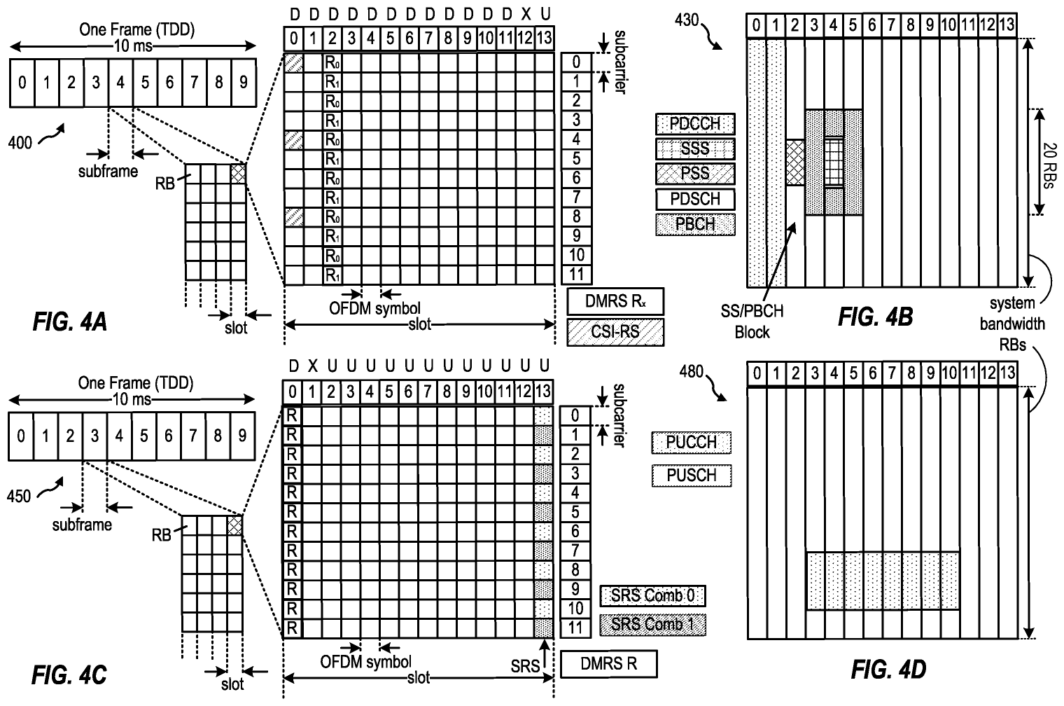

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Secure Wireless Transmission Mechanisms

Aspects of the present disclosure provide mechanisms that may help enhance security relative to previous mechanisms. For example, for half duplex (HD) and full duplex (FD), transmitter devices may transmit AN (with data or separately) according to one or more selected transmission parameter configurations in order to protect transmitted data. As will be described in greater detail below, the configurations may be based on jamming and power tasks a UE is performing and each task may be associated with a slot type and a power configuration. In some cases, a device may have sufficient capability to jam or send energy for a certain average or number of slots.

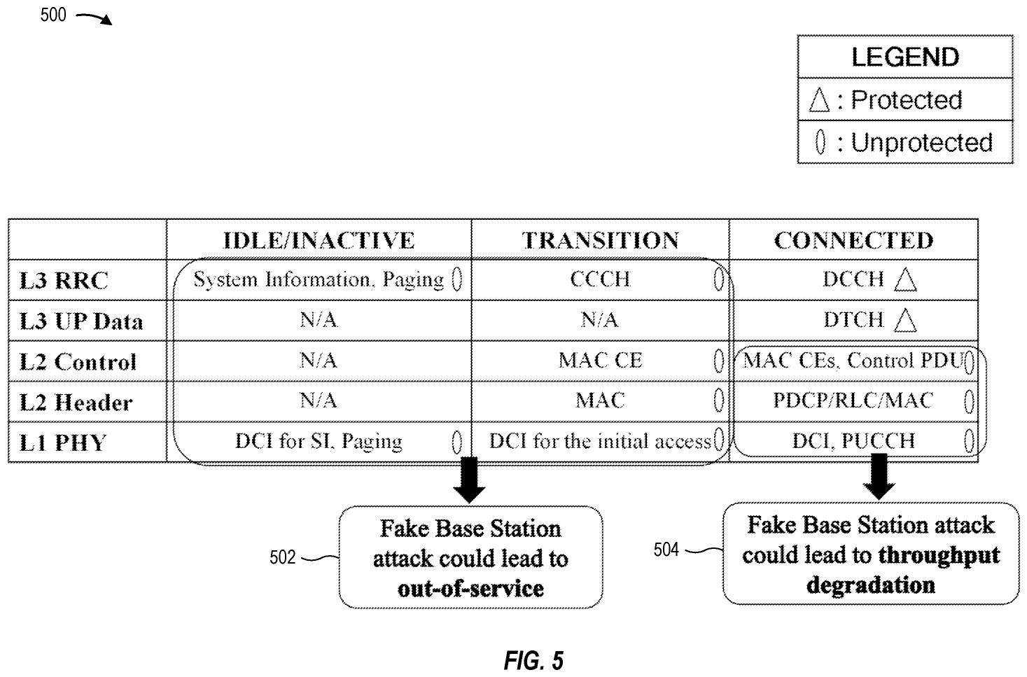

As noted above, secure communications are very important in many wireless communications systems, such as systems involving Internet of Things (IoT) devices, where many such devices will be connected to each other. Given the level of importance of data obtained from IoT devices, adding more security to wireless transmissions may be desirable to avoid attacks, particularly on channels that are currently unprotected (e.g., transmitted without security). As illustrated in table 500 of FIG. 5, such attacks may have a severe impact on system performance, for example, leading to throughput degradation (as illustrated at 504) or OOS events (as illustrated at 502).

The techniques proposed herein may help improve security by adding artificial noise (AN) to transmitted data signals for different slot types, such as UL, DL, subband FD (SBFD), and intra-band FD (IBFD). This may be particularly beneficial to secure certain NR channels, such as PDCCH and PUCCH, that lack L3 security. The techniques may also help add a new layer of security to the physical layer (L1 PHY), which may be particularly beneficial for advanced systems (e.g., NR Release 18, Release 19 and beyond). In such systems, energy transfer may be used, where a transmitting node can send an RF power signal to power a passive IoT device.

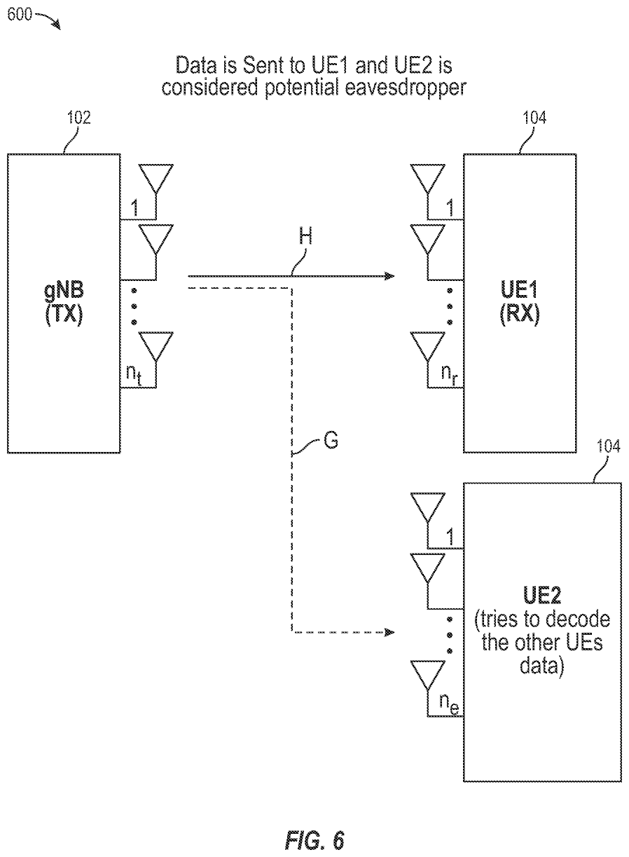

As previously explained, artificial noise (AN) injection is one technique available to improve physical layer security, by injecting AN in a way that it could be canceled or removed at an intended (legitimate) receiver, but not at an unintended receiver (e.g., an eavesdropper). The techniques may be applied in the scenario 600 shown in FIG. 6, for example, to increase security of downlink transmissions from a network entity (e.g., a gNB) to a first UE (UE 1), where a second UE (UE 2) may be considered a potential eavesdropper. In some aspects, the UE(s) shown in FIG. 6 may be examples of the UE 104 depicted and described with respect to FIGS. 1 and 3. Similarly, the network entity/gNB may be an example of the BS 102 (e.g., a gNB) depicted and described with respect to FIGS. 1 and 3, an access point (AP), or a disaggregated base station depicted and described with respect to FIG. 2.

One mechanism to protect such transmissions could involve a first step, of sharing a secret key between legitimate terminals (e.g., the gNB and UE 1 in the example of FIG. 6). The secret keys may be obtained and/or exchanged using various mechanisms. For example, secret keys could be obtained from upper layer techniques, for example, using a Diffie-Hellman (DH) algorithm that is a form of a key-exchange protocol which relies on using a Rivest-Shamir-Adleman (RSA) algorithm or other mechanisms to share keys that rely on Elliptic Curve Cryptography (ECC), or PHY layer using channel reciprocity and randomness.

In a second step, a transmitter may generate AN based on the secret key. For example, a pseudo-random generator with the key as a seed could be used to generate random signals (QAM, Gaussian, uniform, etc.) as AN. In a third step, the receiver may cancel the AN prior to data decoding. Another approach of using secret keys to generate AN is to rotate or remap the QAM points prior to transmission.

Generally, various types of PHY layer security could be used. As noted above, a first type could use QAM rotation or remapping of the constellation points based on a secret key. A same key or rotation could be used for M REs, or the key could be changed every RE. The rotation may be removed/canceled at a legitimate receiver before decoding, since the legitimate receiver has the key that was used for the rotation/remapping.

A second type of PHY layer security could be to add AN (based on a secret key) to each RE (or to add common noise across each of M REs). The legitimate receiver (e.g., UE for DL transmissions) will be able to reconstruct the same AN using the secret key and will be able to cancel it out before decoding.

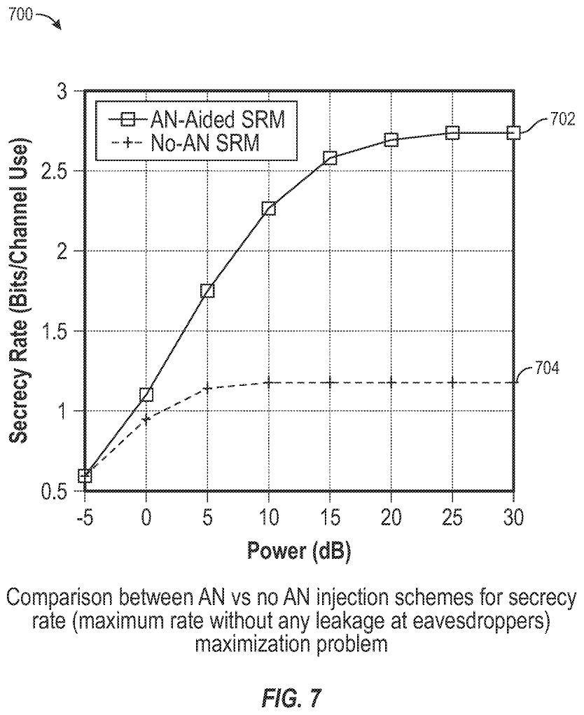

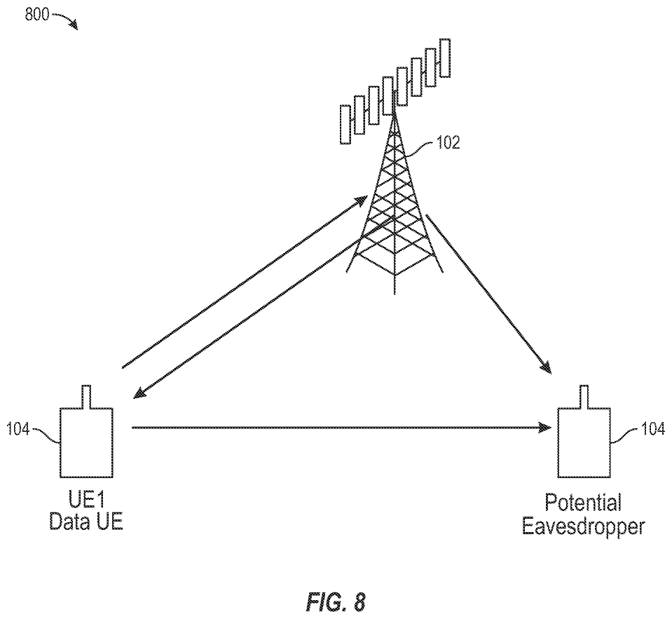

FIG. 7 illustrates the potential impact that AN has on security. Graph 700 compares the secrecy rate of transmission with security enhanced with AN injection 702 to transmissions sent without AN injection 704. For example, the transmissions may correspond to downlink transmissions to a legitimate receiver, such as UE1 illustrated in scenario 800 of FIG. 8, or uplink transmissions from UE1 to a gNB. The secrecy rate may be in terms of bits per channel and may refer to the ability of transmission without detection (of DL transmissions intended for UE 1 or uplink transmissions from UE 1) by a potential eavesdropper (UE2). As illustrated, a much higher secrecy rate is achievable for transmissions with AN injection, particularly at higher transmission power levels.

Transmissions with AN injection may be understood considering a transmission signal Y as:

$$Y = X + Z ,$$

where X is the data, Z is the AN, and the transmission power P is:

$$Px + Pz = P .$$

With no AN injection (Z=0, Px=P), the achievable bit error rate (BER) at any receiver (assuming same channel conditions at all receivers) is a direct function of Px=P. With AN injection (Z>0), assuming additive white Gaussian noise (AWGN) power is No, the achievable BER at a receiver with knowledge of the AN (e.g., UE 1 in FIG. 8 that can cancel Z before decoding X) is a function of Px/No. On the other hand, for a receiver that does not know Z (e.g., eavesdropper UE 2 of FIG. 8), its BER is a function of signal to interference and noise ratio (SINR):

$$SINR = Px / ( Pz + No ) = ( Px / No ) / ( Pz / No + 1 ) .$$

Assuming Z>0, at high Px/No and Pz/No, the BER at the legitimate receiver is near zero (˜0) while the BER at an eavesdropper (or any other attacker without knowledge of AN) is Px/Pz (and, thus, may be controlled by controlling the data/AN power ratios).

In some aspects, the UE(s) shown in FIG. 8 may be examples of the UE 104 depicted and described with respect to FIGS. 1 and 3. Similarly, the network entity/gNB may be an example of the BS 102 (e.g., a gNB) depicted and described with respect to FIGS. 1 and 3, an access point (AP), or a disaggregated base station depicted and described with respect to FIG. 2.

According to certain aspects of the present disclosure, half-duplex (HD) and full duplex (FD) transmitter devices may transmit AN (with data or separately) according to one or more selected transmission parameter configurations in order to protect transmitted data. The configurations may be based on jamming and power tasks a UE is performing. Each task may be associated with a slot type and a power configuration

For example, if a UE is a half-duplex device (or operating in an HD mode), it may only be able to transmit AN and energy signals during UL times (e.g., either in UL slots or SBFD slots) or during DL slots, if indicated by the gNB (and the UE is not receiving). Hence, there could be at least three power configurations: a data signal power configuration, an AN signal power configuration, and an energy signal power configuration. The AN signal power configuration may be used during UL slots on UL BWP or during DL slots on DL BWP (when UL and DL BWPs are the same or flexible BWP is used) or for both when operating in FD mode.

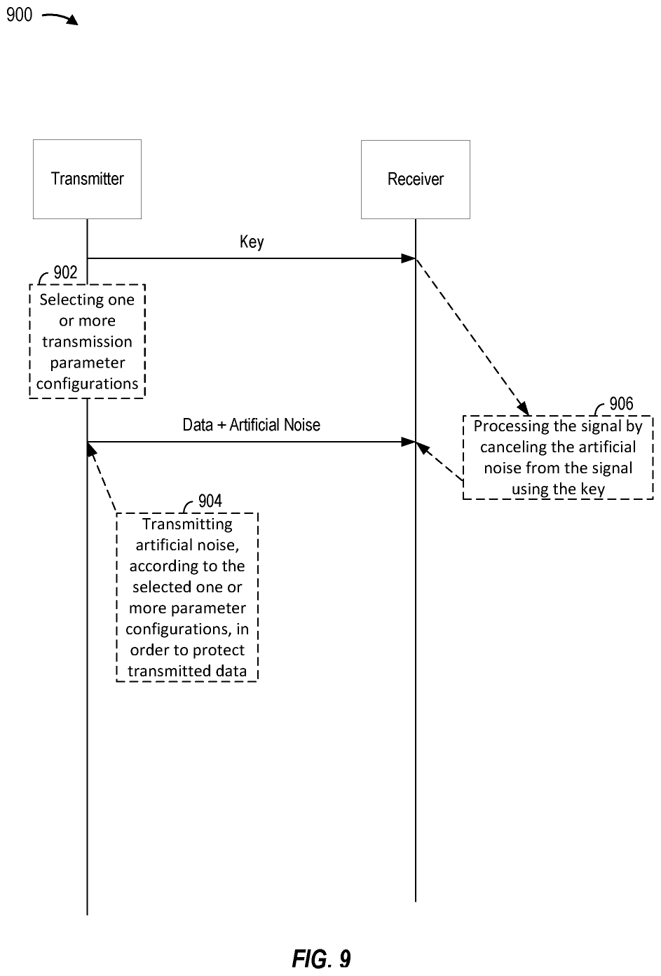

FIG. 9 is a call flow diagram 900 illustrating how AN injection may be used to enhance security of wireless transmissions, according to aspects of the present disclosure. In some aspects, the transmitter and/or receiver shown FIG. 9 may be an example of the UE 104 depicted and described with respect to FIGS. 1 and 3. Similarly, the transmitter and/or receiver may be an example of the BS 102 (e.g., a gNB) depicted and described with respect to FIGS. 1 and 3, an access point (AP), or a disaggregated base station depicted and described with respect to FIG. 2.

As noted above, a transmitter and receiver may obtain a key (using one of the techniques described above). As illustrated, in some cases, the transmitter may generate/obtain a key and provide it to the receiver.

As illustrated at 902, the transmitter may select from one or more of a combination of power configurations, for example, based on which event is active. As illustrated at 904, the transmitter may transmit AN, according to the selected one or more parameter configurations, in order to protect transmitted data. As illustrated at 906, the receiver may process the signal (data+AN) by canceling the AN using the key.

The power configuration selected by the transmitter may depend on an event or current action being taken. For example, a UE may use a first power configuration (e.g., power config 1) for data when energy transfer is enabled and use a second power configuration (e.g., power config 2) for data when energy is disabled. Similarly, the UE could use a combination of power configurations for AN and energy signal transmission.

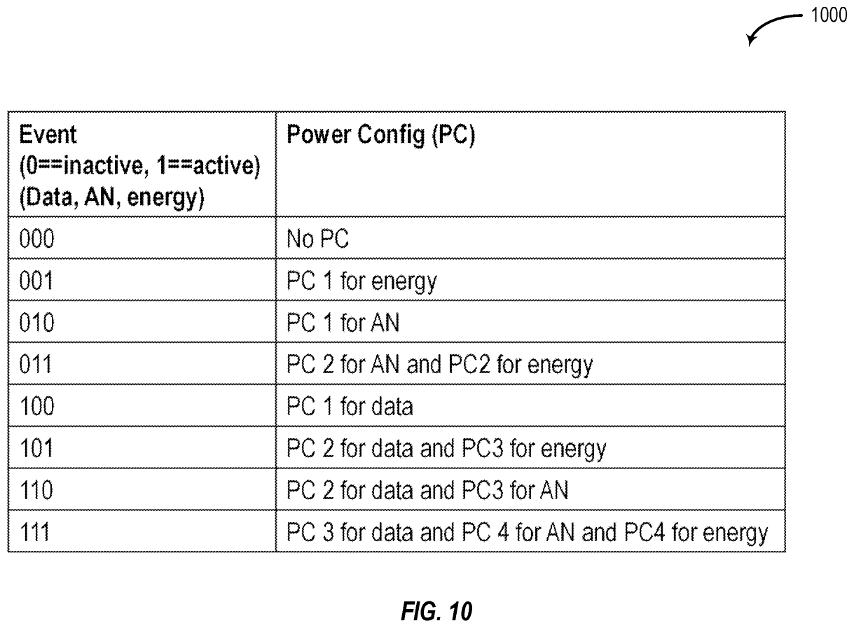

In some cases, a transmitter may select one or more transmission parameter configurations based on a table that maps power configurations to different combinations of the one or more transmission events. For example, table 1000 of FIG. 10 illustrates examples of various types of power configurations (PCs) corresponding to various events. As illustrated, each PC may have an index with a bit that indicates whether data, AN, or energy transfer is inactive (bit=0) or active (bit=1). In the illustrated example, the first bit corresponds to data transmission, the second bit corresponds to AN injection, and the third bit corresponds to energy transmission.

In some cases, there may be a type of ranking or ordering among the different three events (signals) for power allocation. For example, for a higher energy transfer requirement, the priorities may be data first, energy second, and AN third. For a higher security requirement, the priorities may be data first, AN second, and energy signal third. Other orderings or rankings may be based on combination of requirements of data priority, energy, and/or security.

In some cases, ordering or ranking of transmissions may be based, at least in part, on data priority or quality of service (QOS), security priority/QoS, or energy requirement priority/QoS. In some cases, a table could be introduced (e.g., using L1/L2/L3 signaling) to indicate how to order power allocation given certain (data, security, or energy) priority/QoS.

A power configuration may also be selected with consideration to events related to a UE operating in FD mode. For example, during DL transmissions, an FD UE could receive a data signal and could send one or more of an UL data signal or an AN signal in an attempt to confuse other (potentially eavesdropping) devices which receive the DL signal or to confuse eavesdroppers intercepting the UL signal.

In other words, as illustrated in scenario 800 of FIG. 8, both DL and UL signals are subject to eavesdropping and a (legitimate) UE may (be directed to) send jamming signals for both DL and UL signals, as well as an energy signal to an IoT device. Thus, during UL (dynamic or configured) grants, an FD UE may be asked (or instructed) to send an AN signal to secure its own data signal transmission (UL), its own reception (DL), or both.

In some cases, the UE may receive an indication, from the network entity, indicating whether the transmitter is to transmit AN or energy signals using a first power allocation, a second power allocation, or the first and the second power allocations. For example, via (L1/L2/L3) signaling, a network entity may indicate whether a UE is to send AN or energy signals in DL allocated resources, UL allocated resources, or both, to secure transmissions (e.g., and confuse the attackers). To enable this approach, the UE may have overlapping UL and DL BWPs and allocations of U and D (slots/symbols) that are occupying part or all (e.g., via SBFD or IBFD).

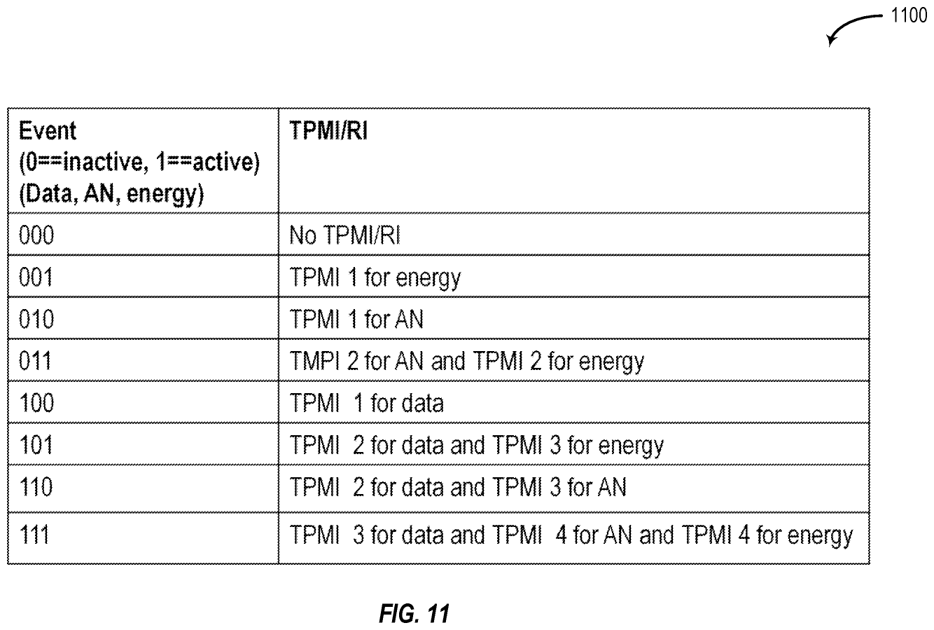

In some cases, one or more transmission parameter configurations may include one or more transmit precoding matrix index (TPMI) and rank indicator (RI) configurations. For example, as illustrated in table 1100 of FIG. 11, a UE may select TPMI and RI configurations, based on a table that maps TPMI and RI configurations to different combinations of the one or more transmission events.

In some cases, a UE may select a transmit precoding matrix index (TPMI) based on an indication received from a network entity. For example, a network entity may send one of three TPMIs, associated with each of the following different types of signals: a TPMI for data, TPMI for energy signal, and a TPMI for AN. The TPMI may depend on how many events (e.g., data, AN, energy) are active at a time. For example, TPMI1 may be indicated for data if energy is enabled with TPMI2, while TPMI1′ may be indicated for data if there is no energy signal transmitted. This TPMI may be associated with data in HD slots (e.g., slots that are different from IBFD slots and from SBFD slots).

Both analog and digital precoders may be used for transmission. A digital precoder may be indicated via a TPMI, as noted above. For analog precoders, a gNB (or controlling UE in sidelink applications) may indicate a UE is to use certain analog beamforming (BF) weights or may indicate the UE is to transmit with an analog BF that was used to transmit a previous SRS or other UL signals and to receive a previous synchronization signal block (SSB)/CSI-RS or other DL signals. In such cases, this indication may be conveyed by indicating the RS ID or TCI state. The indicated RS ID may comprise an uplink RS ID (e.g., an SRS ID) or a downlink RS ID (e.g., a CSI-RS ID or an SSB ID).

In some cases, how or if a transmitter applies security may depend on various factors, such as time division duplexing (TDD) patterns, capability of the transmitter, a wake up signal (WUS), or a certain type of jamming/energy PDCCH.

For example, gNB may indicate transmission parameters (e.g., a TPMI/RI/analog values) for each event (e.g., data, AN, energy signal), based on a TDD pattern. In other words, the indication may determine how the transmitter controls transmission power or jams certain directions during a period of time, corresponding to that TDD pattern. In such cases, a UE AN or energy power could be a function of the TDD pattern. In some cases, the TDD pattern may be configured or indicated via (L1/L2/L3) signaling.

In some cases, a UE may be deployed and used for a specific purpose of enhancing security. For example, a gNB may signal a (designated helper) UE to jam a certain area with a certain zone ID (e.g., if the UE is able to distinguish different zones, based on zone IDs) or certain zones with certain IDs.

There may be limits on how a UE is configured to send AN (or energy) for jamming purposes. For example, in some cases, a UE may be limited to being assigned at most X transmissions or an average power across Y slots/transmissions to send AN (or energy). In some cases, the limitation may be based on a capability (of a transmitter) for jamming or sending energy signals.

In some cases, a WUS may be sent to a UE. For example, via a WUS, a gNB may indicate to the UE whether that UE will participate in jamming or sending energy signals. In some cases, a UE may be instructed (or requested) to participate to transmit AN and/or energy signals during discontinuous reception (DRX) off cycles if needed (e.g., if additional security is deemed more important than power saving for that UE).

In some cases, a particular type of PDCCH may be designed for indicating jamming/energy transfer (e.g., for sending with a WUS or separately). Such a PDCCH may be used with an associated acknowledgment (ACK) or negative acknowledgment NACK, where an ACK may indicate that the UE will be able to participate in jamming/energy transfer to other devices.

In some cases, there may be scheduling/time limits on a UE participating in jamming or energy transfer after receiving a WUS/PDCCH indicating such participation. For example, a UE may not be expected to participate in AN/energy signaling before X_AN or X_En time units (after receiving a PDCCH or WUS). Values of these parameters may be configured or indicated, for example, via the WUS/PDCCH or separate (L1/L2/L3 signaling).

### Example Operations of a Transmitter

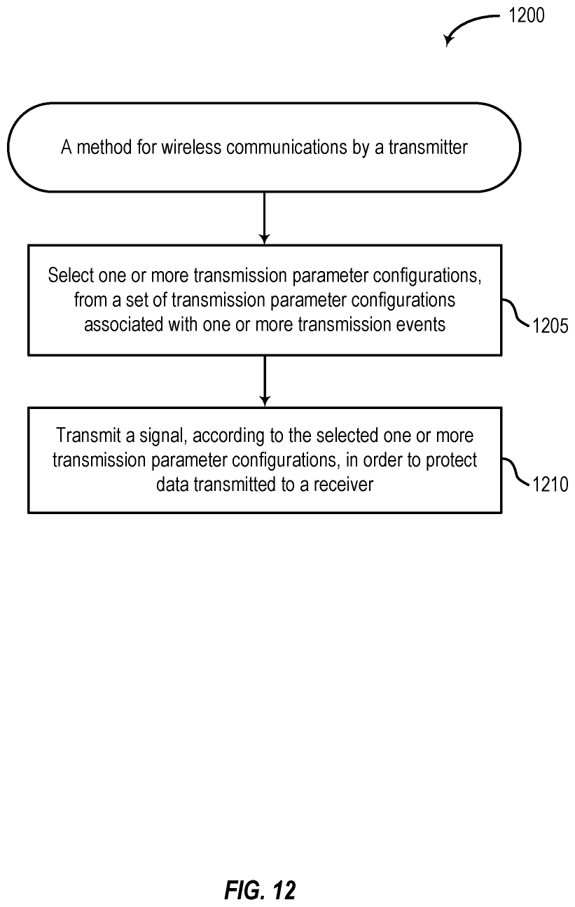

FIG. 12 shows an example of a method 1200 for wireless communications by a transmitter, such as by a UE 104 of FIGS. 1 and 3; or by a network entity, such as BS 102 of FIGS. 1 and 3, or a disaggregated base station as discussed with respect to FIG. 2.

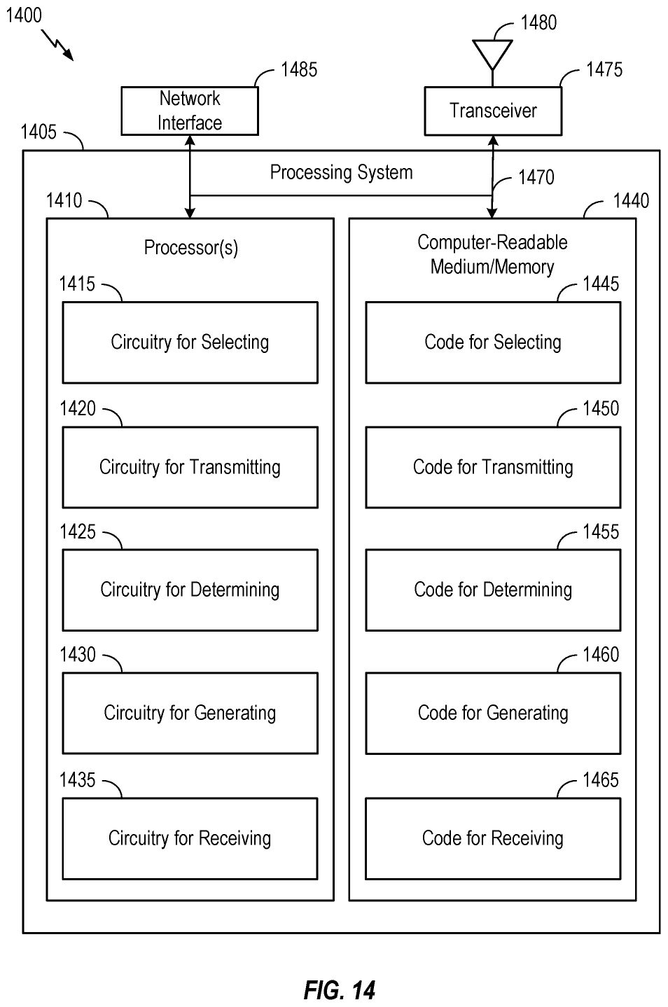

Method 1200 begins at step 1205 with selecting one or more transmission parameter configurations, from a set of transmission parameter configurations associated with one or more transmission events. In some cases, the operations of this step refer to, or may be performed by, circuitry for selecting and/or code for selecting as described with reference to FIG. 14.

Method 1200 then proceeds to step 1210 with transmitting a signal, according to the selected one or more transmission parameter configurations, in order to protect data transmitted to a receiver. In some cases, the operations of this step refer to, or may be performed by, circuitry for transmitting and/or code for transmitting as described with reference to FIG. 14.

In some aspects, the method 1200 further includes determining a key, shared with the receiver. In some cases, the operations of this step refer to, or may be performed by, circuitry for determining and/or code for determining as described with reference to FIG. 14.

In some aspects, the method 1200 further includes generating AN based on the key, wherein transmitting the signal comprises transmitting the AN or transmitting the data with the AN. In some cases, the operations of this step refer to, or may be performed by, circuitry for generating and/or code for generating as described with reference to FIG. 14.

In some aspects, determining the key comprises determining the key by using a symmetric key consensus algorithm.

In some aspects, determining the key comprises determining the key based on an algorithm that uses one or more values associated with channel reciprocity.

In some aspects, the one or more transmission events comprise at least one of a data transmission event, an energy signal transmission event, and an signal transmission event.

In some aspects, the selecting one or more transmission parameter configurations comprises selecting one or more power configurations based on a table that maps power configurations to different combinations of the one or more transmission events.

In some aspects, the method 1200 further includes determining a ranking associated with each of the one or more transmission events. In some cases, the operations of this step refer to, or may be performed by, circuitry for determining and/or code for determining as described with reference to FIG. 14.

In some aspects, each ranking is determined based on one or more of a data priority, a data QoS, a security priority, a security QoS, an energy requirement priority, and an energy QoS.

In some aspects, each ranking is determined based on a table that indicates how to rank transmission events based on priority values associated with each of data, security, and energy requirements.

In some aspects, the method 1200 further includes receiving an indication, from a network entity, indicating whether the transmitter is to transmit AN or energy signals using a first power allocation, a second power allocation, or the first and the second power allocations. In some cases, the operations of this step refer to, or may be performed by, circuitry for receiving and/or code for receiving as described with reference to FIG. 14.

In some aspects, the selecting one or more transmission parameter configurations comprises selecting one or more TPMI and RI configurations based on a table that maps TPMI and RI configurations to different combinations of the one or more transmission events.

In some aspects, the selecting one or more transmission parameter configurations comprises selecting a TPMI based on an indication received from a network entity.

In some aspects, the indication is conveyed via one of: a TCI state indicator; or an RS ID.

In some aspects, the selected TPMI indicates that the transmitter is to use an analog precoder for transmitting the signal; and one of the TCI state indicator or the RS ID indicates analog BF weights that the transmitter is to use for transmitting the signal.

In some aspects, the indicated analog BF weights are associated with one of: a previously performed transmission of one or more uplink signals; or a previously performed reception of one or more downlink signals.

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative steps are possible consistent with this disclosure.

### Example Operations of a Receiver

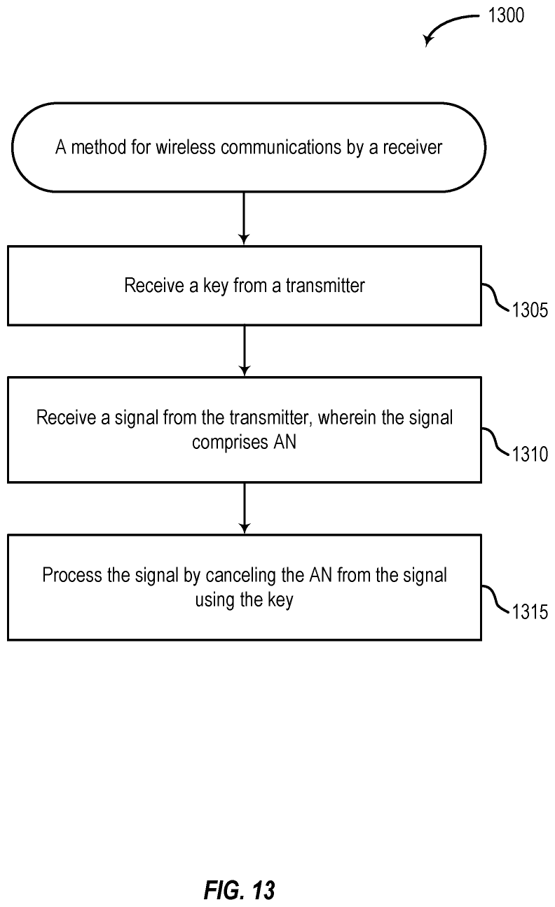

FIG. 13 shows an example of a method 1300 for wireless communications by a receiver, such as by a UE 104 of FIGS. 1 and 3; or by a network entity, such as BS 102 of FIGS. 1 and 3, or a disaggregated base station as discussed with respect to FIG. 2.

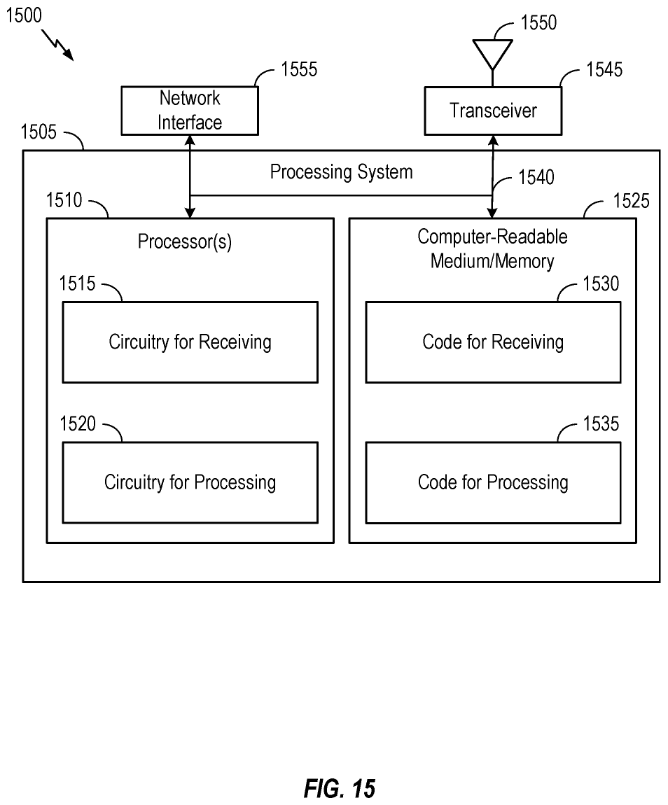

Method 1300 begins at step 1305 with receiving a key from a transmitter. In some cases, the operations of this step refer to, or may be performed by, circuitry for receiving and/or code for receiving as described with reference to FIG. 15.

Method 1300 then proceeds to step 1310 with receiving a signal from the transmitter, wherein the signal comprises AN. In some cases, the operations of this step refer to, or may be performed by, circuitry for receiving and/or code for receiving as described with reference to FIG. 15.

Method 1300 then proceeds to step 1315 with processing the signal by canceling the AN from the signal using the key. In some cases, the operations of this step refer to, or may be performed by, circuitry for processing and/or code for processing as described with reference to FIG. 15.

In some aspects, the signal further comprises data; and the AN protects the data.

In some aspects, the AN is generated based on the key.

In some aspects, the signal is transmitted using one or more transmission parameter configurations from a set of transmission parameter configurations associated with one or more transmission events.

In one aspect, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

### Example Communications Devices

FIG. 14 depicts aspects of an example communications device 1400. In some aspects, communications device 1400 is a user equipment, such as UE 104 described above with respect to FIGS. 1 and 3. In some aspects, communications device 1400 is a network entity, such as BS 102 of FIGS. 1 and 3, or a disaggregated base station as discussed with respect to FIG. 2.

The communications device 1400 includes a processing system 1405 coupled to the transceiver 1475 (e.g., a transmitter and/or a receiver). In some aspects (e.g., when communications device 1400 is a network entity), processing system 1405 may be coupled to a network interface 1485 that is configured to obtain and send signals for the communications device 1400 via communication link(s), such as a backhaul link, midhaul link, and/or fronthaul link as described herein, such as with respect to FIG. 2. The transceiver 1475 is configured to transmit and receive signals for the communications device 1400 via the antenna 1480, such as the various signals as described herein. The processing system 1405 may be configured to perform processing functions for the communications device 1400, including processing signals received and/or to be transmitted by the communications device 1400.

The processing system 1405 includes one or more processors 1410. In various aspects, the one or more processors 1410 may be representative of one or more of receive processor 358, transmit processor 364, TX MIMO processor 366, and/or controller/processor 380, as described with respect to FIG. 3. In various aspects, one or more processors 1410 may be representative of one or more of receive processor 338, transmit processor 320, TX MIMO processor 330, and/or controller/processor 340, as described with respect to FIG. 3. The one or more processors 1410 are coupled to a computer-readable medium/memory 1440 via a bus 1470. In certain aspects, the computer-readable medium/memory 1440 is configured to store instructions (e.g., computer-executable code) that when executed by the one or more processors 1410, cause the one or more processors 1410 to perform the method 1200 described with respect to FIG. 12, or any aspect related to it. Note that reference to a processor performing a function of communications device 1400 may include one or more processors 1410 performing that function of communications device 1400.

In the depicted example, computer-readable medium/memory 1440 stores code (e.g., executable instructions), such as code for selecting 1445, code for transmitting 1450, code for determining 1455, code for generating 1460, and code for receiving 1465. Processing of the code for selecting 1445, code for transmitting 1450, code for determining 1455, code for generating 1460, and code for receiving 1465 may cause the communications device 1400 to perform the method 1200 described with respect to FIG. 12, or any aspect related to it.

The one or more processors 1410 include circuitry configured to implement (e.g., execute) the code stored in the computer-readable medium/memory 1440, including circuitry such as circuitry for selecting 1415, circuitry for transmitting 1420, circuitry for determining 1425, circuitry for generating 1430, and circuitry for receiving 1435. Processing with circuitry for selecting 1415, circuitry for transmitting 1420, circuitry for determining 1425, circuitry for generating 1430, and circuitry for receiving 1435 may cause the communications device 1400 to perform the method 1200 described with respect to FIG. 12, or any aspect related to it.

Various components of the communications device 1400 may provide means for performing the method 1200 described with respect to FIG. 12, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1475 and the antenna 1480 of the communications device 1400 in FIG. 14. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1475 and the antenna 1480 of the communications device 1400 in FIG. 14.

FIG. 15 depicts aspects of an example communications device 1500. In some aspects, communications device 1500 is a user equipment, such as UE 104 described above with respect to FIGS. 1 and 3. In some aspects, communications device 1500 is a network entity, such as BS 102 of FIGS. 1 and 3, or a disaggregated base station as discussed with respect to FIG. 2.

The communications device 1500 includes a processing system 1505 coupled to the transceiver 1545 (e.g., a transmitter and/or a receiver). In some aspects (e.g., when communications device 1500 is a network entity), processing system 1505 may be coupled to a network interface 1555 that is configured to obtain and send signals for the communications device 1500 via communication link(s), such as a backhaul link, midhaul link, and/or fronthaul link as described herein, such as with respect to FIG. 2. The transceiver 1545 is configured to transmit and receive signals for the communications device 1500 via the antenna 1550, such as the various signals as described herein. The processing system 1505 may be configured to perform processing functions for the communications device 1500, including processing signals received and/or to be transmitted by the communications device 1500.

The processing system 1505 includes one or more processors 1510. In various aspects, the one or more processors 1510 may be representative of one or more of receive processor 358, transmit processor 364, TX MIMO processor 366, and/or controller/processor 380, as described with respect to FIG. 3. In various aspects, one or more processors 1510 may be representative of one or more of receive processor 338, transmit processor 320, TX MIMO processor 330, and/or controller/processor 340, as described with respect to FIG. 3. The one or more processors 1510 are coupled to a computer-readable medium/memory 1525 via a bus 1540. In certain aspects, the computer-readable medium/memory 1525 is configured to store instructions (e.g., computer-executable code) that when executed by the one or more processors 1510, cause the one or more processors 1510 to perform the method 1300 described with respect to FIG. 13, or any aspect related to it. Note that reference to a processor performing a function of communications device 1500 may include one or more processors 1510 performing that function of communications device 1500.

In the depicted example, computer-readable medium/memory 1525 stores code (e.g., executable instructions), such as code for receiving 1530 and code for processing 1535. Processing of the code for receiving 1530 and code for processing 1535 may cause the communications device 1500 to perform the method 1300 described with respect to FIG. 13, or any aspect related to it.

The one or more processors 1510 include circuitry configured to implement (e.g., execute) the code stored in the computer-readable medium/memory 1525, including circuitry such as circuitry for receiving 1515 and circuitry for processing 1520. Processing with circuitry for receiving 1515 and circuitry for processing 1520 may cause the communications device 1500 to perform the method 1300 described with respect to FIG. 13, or any aspect related to it.

Various components of the communications device 1500 may provide means for performing the method 1300 described with respect to FIG. 13, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1545 and the antenna 1550 of the communications device 1500 in FIG. 15. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1545 and the antenna 1550 of the communications device 1500 in FIG. 15.

### Example Clauses

Implementation examples are described in the following numbered clauses:

Clause 1: A method for wireless communication, by a transmitter, comprising: selecting one or more transmission parameter configurations, from a set of transmission parameter configurations associated with one or more transmission events; and transmitting a signal, according to the selected one or more transmission parameter configurations, in order to protect data transmitted to a receiver.

Clause 2: The method of Clause 1, further comprising: determining a key, shared with the receiver; and generating AN based on the key, wherein transmitting the signal comprises transmitting the AN or transmitting the data with the AN.

Clause 3: The method of Clause 2, wherein determining the key comprises determining the key by using a symmetric key consensus algorithm.

Clause 4: The method of Clause 2, wherein determining the key comprises determining the key based on an algorithm that uses one or more values associated with channel reciprocity.

Clause 5: The method of Clause 2, wherein the one or more transmission events comprise at least one of a data transmission event, an energy signal transmission event, and an signal transmission event.

Clause 6: The method of Clause 5, wherein: the selecting one or more transmission parameter configurations comprises selecting one or more power configurations based on a table that maps power configurations to different combinations of the one or more transmission events.

Clause 7: The method of Clause 6, further comprising: determining a ranking associated with each of the one or more transmission events.

Clause 8: The method of Clause 7, wherein each ranking is determined based on one or more of a data priority, a data QoS, a security priority, a security QoS, an energy requirement priority, and an energy QoS.

Clause 9: The method of Clause 7, wherein each ranking is determined based on a table that indicates how to rank transmission events based on priority values associated with each of data, security, and energy requirements.

Clause 10: The method of Clause 5, further comprising: receiving an indication, from a network entity, indicating whether the transmitter is to transmit AN or energy signals using a first power allocation, a second power allocation, or the first and the second power allocations.

Clause 11: The method of Clause 5, wherein: the selecting one or more transmission parameter configurations comprises selecting one or more TPMI and RI configurations based on a table that maps TPMI and RI configurations to different combinations of the one or more transmission events.

Clause 12: The method of any one of Clauses 1-11, wherein the selecting one or more transmission parameter configurations comprises selecting a TPMI based on an indication received from a network entity.

Clause 13: The method of Clause 12, wherein the indication is conveyed via one of: a TCI state indicator; or an RS ID.

Clause 14: The method of Clause 13, wherein: the selected TPMI indicates that the transmitter is to use an analog precoder for transmitting the signal; and one of the TCI state indicator or the RS ID indicates analog BF weights that the transmitter is to use for transmitting the signal.

Clause 15: The method of Clause 14, wherein the indicated analog BF weights are associated with one of: a previously performed transmission of one or more uplink signals; or a previously performed reception of one or more downlink signals.

Clause 16: A method for wireless communication, by a receiver, comprising: receiving a key from a transmitter; receiving a signal from the transmitter, wherein the signal comprises AN; and processing the signal by canceling the AN from the signal using the key.

Clause 17: The method of Clause 16, wherein: the signal further comprises data; and the AN protects the data.

Clause 18: The method of any one of Clauses 16 and 17, wherein the AN is generated based on the key.

Clause 19: The method of any one of Clauses 16-18, wherein the signal is transmitted using one or more transmission parameter configurations from a set of transmission parameter configurations associated with one or more transmission events.

Clause 20: An apparatus, comprising: a memory comprising executable instructions; and a processor configured to execute the executable instructions and cause the apparatus to perform a method in accordance with any one of Clauses 1-19.

Clause 21: An apparatus, comprising means for performing a method in accordance with any one of Clauses 1-19.

Clause 22: A non-transitory computer-readable medium comprising executable instructions that, when executed by a processor of an apparatus, cause the apparatus to perform a method in accordance with any one of Clauses 1-19.

Clause 23: A computer program product embodied on a computer-readable storage medium comprising code for performing a method in accordance with any one of Clauses 1-19.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication at a transmitter, comprising: a memory comprising computer-executable instructions; and one or more processors configured to execute the computer-executable instructions and cause the apparatus to:
select one or more transmission parameter configurations, from a set of transmission parameter configurations associated with one or more transmission events; and
transmit a signal, according to the selected one or more transmission parameter configurations, in order to protect data transmitted to a receiver.

2. The apparatus of claim 1, wherein the one or more processors are further configured to execute the computer-executable instructions and cause the apparatus to:
determine a key, shared with the receiver; and
generate artificial noise (AN) based on the key, wherein transmitting the signal comprises transmitting the AN or transmitting the data with the AN.

3. The apparatus of claim 2, wherein determining the key comprises determining the key by using a symmetric key consensus algorithm.

4. The apparatus of claim 2, wherein determining the key comprises determining the key based on an algorithm that uses one or more values associated with channel reciprocity.

5. The apparatus of claim 2, wherein the one or more transmission events comprise at least one of a data transmission event, an energy signal transmission event, and an AN signal transmission event.

6. The apparatus of claim 5, wherein:
the selecting one or more transmission parameter configurations comprises selecting one or more power configurations based on a table that maps power configurations to different combinations of the one or more transmission events.

7. The apparatus of claim 6, wherein the one or more processors are further configured to execute the computer-executable instructions and cause the apparatus to determine a ranking associated with each of the one or more transmission events.

8. The apparatus of claim 7, wherein each ranking is determined based on one or more of a data priority, a data quality of service (QOS), a security priority, a security QoS, an energy requirement priority, and an energy QoS.

9. The apparatus of claim 7, wherein each ranking is determined based on a table that indicates how to rank transmission events based on priority values associated with each of data, security, and energy requirements.

10. The apparatus of claim 5, wherein the one or more processors are further configured to execute the computer-executable instructions and cause the apparatus to receive an indication, from a network entity, indicating whether the transmitter is to transmit AN or energy signals using a first power allocation, a second power allocation, or the first and the second power allocations.

11. The apparatus of claim 5, wherein:
the selecting one or more transmission parameter configurations comprises selecting one or more transmit precoding matrix index (TPMI) and rank indicator (RI) configurations based on a table that maps TPMI and RI configurations to different combinations of the one or more transmission events.

12. The apparatus of claim 1, wherein the selecting one or more transmission parameter configurations comprises selecting a transmit precoding matrix index (TPMI) based on an indication received from a network entity.

13. The apparatus of claim 12, wherein the indication is conveyed via one of:
a transmission configuration indicator (TCI) state indicator; or
a reference signal (RS) identifier (RS ID).

14. The apparatus of claim 13, wherein:
the selected TPMI indicates that the transmitter is to use a digital precoder for transmitting the signal; and
one of the TCI state indicator or the RS ID indicates analog beamforming (BF) weights that the transmitter is to use for transmitting the signal.

15. The apparatus of claim 14, wherein the indicated analog BF weights are associated with one of:
a previously performed transmission of one or more uplink signals; or
a previously performed reception of one or more downlink signals.

16. An apparatus for wireless communication at a receiver, comprising: a memory comprising computer-executable instructions; and one or more processors configured to execute the computer-executable instructions and cause the apparatus to:
receive a key from a transmitter;
receive a signal from the transmitter, wherein the signal comprises artificial noise (AN); and
process the signal by canceling the AN from the signal using the key.

17. The apparatus of claim 16, wherein:
the signal further comprises data; and
the AN protects the data.

18. The apparatus of claim 16, wherein the AN is generated based on the key.

19. The apparatus of claim 16, wherein the signal is transmitted using one or more transmission parameter configurations from a set of transmission parameter configurations associated with one or more transmission events.

20. A method for wireless communication, by a transmitter, comprising:
selecting one or more transmission parameter configurations, from a set of transmission parameter configurations associated with one or more transmission events; and
transmitting a signal, according to the selected one or more transmission parameter configurations, in order to protect data transmitted to a receiver.

21. The method of claim 20, further comprising:
determining a key, shared with the receiver; and
generating artificial noise (AN) based on the key, wherein transmitting the signal comprises transmitting the AN or transmitting the data with the AN.

22. The method of claim 21, wherein determining the key comprises:
determining the key by using a symmetric key consensus algorithm; or
determining the key based on an algorithm that uses one or more values associated with channel reciprocity.

23. The method of claim 21, wherein the one or more transmission events comprise at least one of a data transmission event, an energy signal transmission event, and an AN signal transmission event.

24. The method of claim 23, wherein:
the selecting one or more transmission parameter configurations comprises selecting one or more power configurations based on a table that maps power configurations to different combinations of the one or more transmission events.

25. The method of claim 20, wherein the selecting one or more transmission parameter configurations comprises selecting a transmit precoding matrix index (TPMI) based on an indication received from a network entity.

26. The method of claim 25, wherein the indication is conveyed via one of:
a transmission configuration indicator (TCI) state indicator; or
a reference signal (RS) identifier (RS ID).

27. A method for wireless communication, by a receiver, comprising:
receiving a key from a transmitter;
receiving a signal from the transmitter, wherein the signal comprises artificial noise (AN); and
processing the signal by canceling the AN from the signal using the key.

28. The method of claim 27, wherein:
the signal further comprises data; and
the AN protects the data.

29. The method of claim 27, wherein the AN is generated based on the key.

30. The method of claim 27, wherein the signal is transmitted using one or more transmission parameter configurations from a set of transmission parameter configurations associated with one or more transmission events.
